(19) United States
(12) Patent Application Publication
(10) Pub. No.: US 2009/0051232 A1
(43) Pub. Date: Feb. 26, 2009

(54) Coolant Pump for Electric Motors

(75) Inventor: Guenter Strelow, Bochum (DE)

Correspondence Address: K.F. ROSS P.C., 5683 RIVERDALE AVENUE, SUITE 203 BOX 900, BRONX, NY, 10471-0900, US

(73) Assignee: WILO AG, Dortmund (DE)

(21) Appl. No.: 11/990,408

(22) PCT Filed: Jul. 21, 2006
(86) PCT No.: PCT/EP2006/007184

§ 371 Date: Feb. 13, 2008

(30) Foreign Application Priority Data
Aug. 12, 2005 (DE) 10 2005 038 209.6

(51) Int. Cl. H02K 9/19; F28D 15/00

(52) U.S. Cl. 310/54; 165/104.32

(57) ABSTRACT

The invention relates to a liquid-cooled electric motor (1) comprising an internal coolant circuit (7) driven by a motor-driven rotary coolant pump (8). Said coolant pump (8) is partially or entirely arranged inside the housing (6) of the electric motor, (1) with a shaft (8a) which is separate from the shaft (2) of the electric motor.

The invention relates to a fluid-cooled electric motor having an internal cooling circuit through flown by a rotary-motor cooling pump.

Large electric motors require cooling units for dissipating heat. Both gases and fluid media are utilized as cooling mediums. Since convection is usually not sufficient for the dissipation of power, ventilators or pumps are used for generating flow.

Often it is the electric motor that drives these components. The impeller or pump wheel is directly connected to the shaft of the motor. If rotation speeds other than the nominal shaft rotation speed are required, solutions having an intermediary transmission or clutches are used. With pumps that have to be utilized in explosive environments, these components must additionally meet the EX protection requirements (prevention of sparks). Commonly, such components are produced in small quantities only, and are very expensive. Thus, they have a substantial influence on the costs of the entire assembly. Due to the rigid coupling using the shaft of the motor, the cooling medium is circulated even if there is no need for cooling. This reduces the performance efficiency of the machine.

It is therefore an object of the invention to improve the drive of the cooling circuit of an electric motor in such a manner that a construction that is easy to make is produced, that enables easy installation, that makes it possible to adjust the cooling power so it is tailored to the individual need, and particularly that makes measures for EX protection unnecessary.

This object is attained according to the invention in that the cooling pump has a shaft separate from the electric-motor shaft and is partially or completely within the housing of the electric motor.

A wet-rotor pump, produced in large quantities, is installed into the electric motor. In this manner, significant cost reductions can be achieved, and the pump can be operated independently of the rotation speed of the shaft. This means that the medium is circulated only, if cooling is required. With the use of a pump with variable rotation speed, the cooling output can be adjusted according to need. With the installation of the pump in the motor, additional measures for EX protection are not necessary, or can be done at a significantly reduced expense as opposed to externally operated assemblies.

Advantageous embodiments of the invention are described in the dependent claims.

One embodiment of the invention is illustrated in the drawings, and is explained in further detail below. In the drawings:

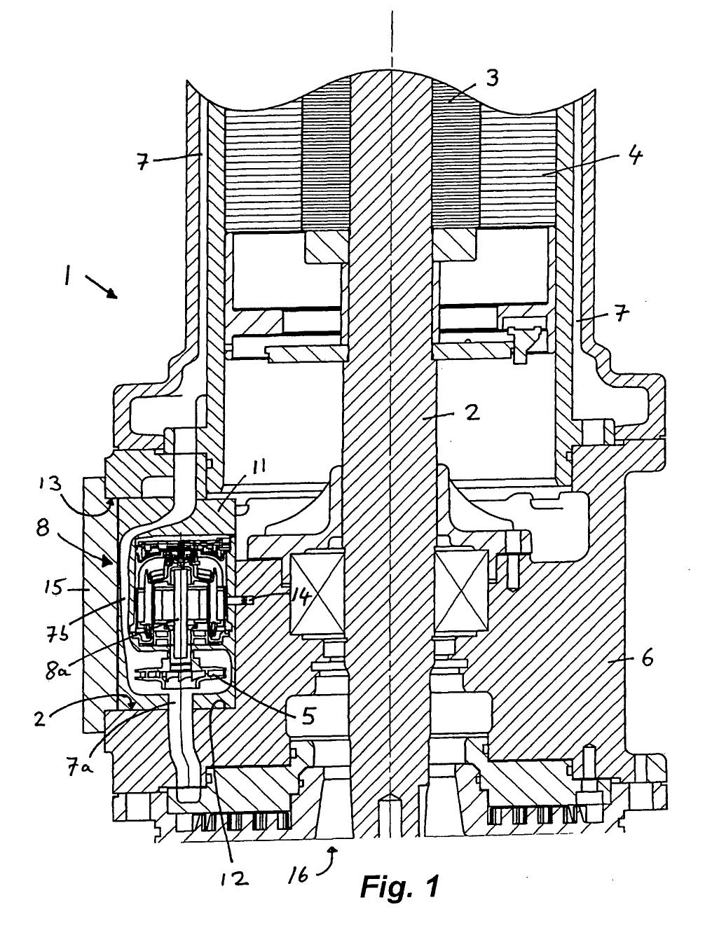

FIG. 1 is an axial section through the electric motor of a rotary-motor pump, and

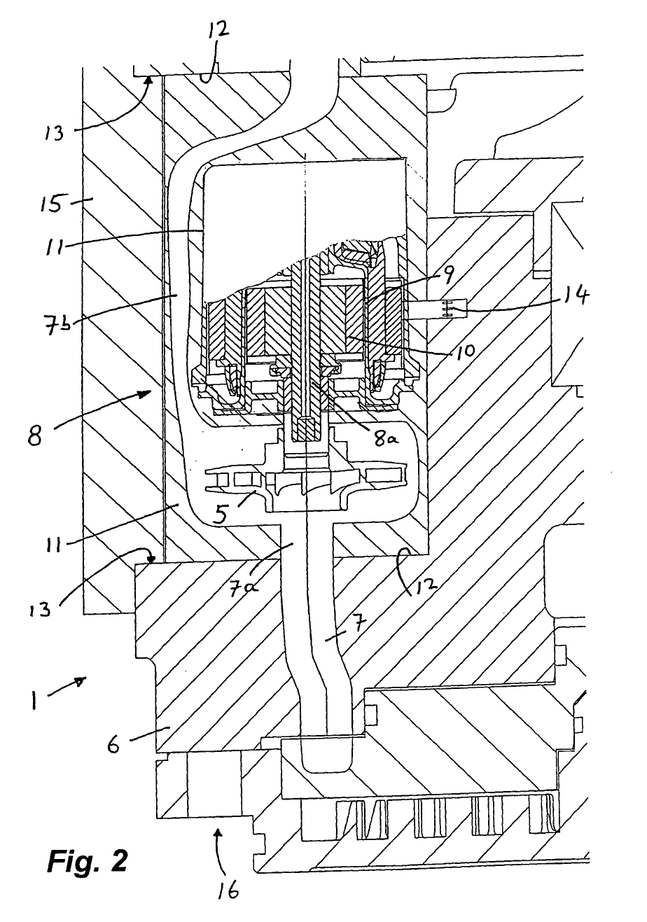

FIG. 2 is a section of FIG. 1.

The electric motor 1 of a rotary-motor pump has a motor shaft 2 carrying a rotor 3 that is surrounded by a stator winding 4. At one end of the motor shaft 2 the shaft of a rotary pump (not illustrated) is coaxially connected to this rotor, the pump housing being attached to the motor housing 6.

Inside the motor housing 6 are the passages 7 of a cooling circuit whose coolant is circulated by a separate motor\pump assembly that has a rotary pump driven by an electric motor, and is hereinafter referred to as the “cooling pump” 8. The cooling pump 8 is a wet-rotor pump with a rotor 10 mounted in a separating can 9, seated on a shaft 8a that carries the pump impeller 5 at its end. Instead of the separating can, the rotor may also be surrounded by a rotor tube.

The cooling pump 8 aspirates the coolant with its impeller 5 via a coaxial passage 7a formed in the cooling pump housing 11, and feeds it to a passage 7b that extends radially in the cooling pump housing 11 along to the motor stator.

The housing 6 of the electric motor 1 to be cooled forms an externally accessible compartment 12 that is open to the exterior around the electric motor 1 (opening 13), as long as the opening 13 is not closed. The cooling pump 8 with its housing 11 can be inserted into the compartment 12 from the exterior in a snug fit, the dimensions of a cooling pump housing 11 corresponding to the interior dimensions of the compartment 12. The electrical connections of the cooling pump 8 to the electrical connections in the compartment 12 are effected via the plug-in connectors 14 that are attached on the outside of the housing 11, and on the inside of the compartment 12 so that after inserting the cooling pump 8 the connections are closed.

Similarly to the fitting of the coolant pump 8 into the compartment 12, the passages 7, 7a, and 7b are formed in inner and outer housing walls. After installing the cooling pump 8, the compartment 12, or its opening 13, is closed by means of a cover 15 that fits on or in from the exterior.

The cooling pump 8 can be controlled with or without feedback in that it is switched off some times, and has on times of varying lengths.

As an alternative, the rotation speed of the cooling pump 8 can be controlled independently of the rotation speed of the electric motor 1. In both cases an optimum and accurate cooling can be achieved without any unnecessary cooling expenditure.

In the embodiment the compartment 12 is open laterally of the motor housing 6 when the cover 15 removed. However, the compartment 12 can also be open toward an end 16 of the motor housing 6. Furthermore, the cover may be omitted, if the compartment 12 and its opening 13 are filled by the housing 11 of the cooling pump 8 in a sealing manner. In this case, the cooling pump and its housing 11 may project over the housing 6. In the latter case a domed cover may surround the projecting housing 11.

1. A fluid-cooled electric motor with an internal cooling circuit throughflown by a rotary-motor cooling pump wherein the cooling pump is provided with a shaft that is separate of the electric motor shaft and is partially or completely within the housing of the electric motor.

2. The electric motor according to claim 1 wherein the cooling pump is a wet-rotor pump whose rotor runs within a separating tube or can.

3. The electric motor according to claims 1 wherein the rotation speed of the cooling pump can be controlled independently of the rotation speed of the electric motor.

4. The electric motor according to claim 1 wherein the electric motor has a compartment accessible from the exterior, into which the cooling pump can be inserted from outside.

5. The electric motor according to claim 4 wherein the compartment forms in an outside wall of the electric motor housing an opening through which the cooling pump can be inserted, and which can be closed particularly by means of a cover or by the cooling pump housing.

6. The electric motor according to claim 4 wherein the cooling pump is connected to the electric or hydraulic connections of the electric motor by means of plug-in connectors.

7. The electric motor according to claim 1 wherein the electric motor is the drive of a motor pump, particularly of a rotary pump.

8. In combination:
an electric motor having
a housing formed with a coolant passage,
a rotor in the housing, and
a shaft carrying the rotor and projecting along a motor axis from the housing; and
a coolant pump having
a housing at least partially recessed in the motor housing,
a rotor in the pump housing,
a shaft carrying the rotor and projecting along a pump axis from the pump housing, the pump shaft being offset from and not attached to the motor shaft, and
an impeller on the pump shaft, the coolant passage of the motor housing extending through the pump housing and past the impeller.

9. The combination defined in claim 8 wherein the pump is a wet-rotor pump and the pump housing includes a can encasing the pump rotor.

10. The combination defined in claim 8 wherein a rotation speed of the pump rotor is independent of a rotation speed of the motor rotor.

11. The combination defined in claim 8 wherein the motor housing is formed with an outwardly open compartment in which the pump housing is fitted and through which the passage extends.

12. The combination defined in claim 11 wherein the compartment has a mouth at an outer surface of the motor housing and the motor housing includes a cover removably fitted over and closing the mouth.

13. The combination defined in claim 11, further comprising:
interengageable connectors on the pump housing and in the compartment fittable together when the pump housing is installed in the compartment, whereby power can be supplied to the pump through the connectors.

14. The combination defined in claim 13 wherein the connectors are electrical connectors.

15. The combination defined in claim 8, further comprising
a rotary pump connected to the motor shaft.

16. The combination defined in claim 8 wherein the motor axis and the pump axis are generally parallel and offset to each other.

17. The combination defined in claim 8 wherein the impeller is an axial-input/radial output impeller and the passage opens axially of the pump axis at the impeller.

18. The combination defined in claim 8 wherein the motor housing is double-walled and the passage is at least partially formed between the walls of the motor housing.
